(19) United States
(12) Patent Application Publication
(10) Pub. No.: US 2016/0050280 A1
(43) Pub. Date: Feb. 18, 2016

(54) Wireless Access Point for Facilitating Bidirectional, Application-Layer Communication Among Computing Devices

(71) Applicant: Smart Technologies ULC, Calgary (CA)

(72) Inventors: James Ong, Calgary (CA); Michael Rounding, Calgary (CA)

(21) Appl. No.: 14/460,810

(22) Filed: Aug. 15, 2014

(51) Int. Cl. H04L 29/08; H04W 72/04; H04W 4/00; H04W 76/02; H04W 12/08

(52) U.S. Cl. CPC H04L 67/141; H04W 76/023; H04W 12/08; H04W 4/008; H04W 72/0426

(57) ABSTRACT

Systems, devices, and methods are provided for establishing bidirectional communication among computing devices. In some aspects, a wireless access establishes a communication link with a first computing device. The access point identifies, based on communications between the first computing device and the access point, an application executed on the first computing device. The access point determines that a second computing device that is in communication with the access point can present outputs generated by the application and generate input events usable by the application. The access point transmits a notification to the first computing device that the second computing device is accessible via the access point. The access point can transmit the notification based on determining that the second computing device can present the outputs and generate the input events that are usable by the application.

### TECHNICAL FIELD

This disclosure relates generally to computer-implemented methods and systems for remote device management and more particularly relates to wireless access points for facilitating bidirectional communication among computing devices.

### BACKGROUND

Users of portable electronic devices may wish to mirror electronic content displayed on a computing device with a smaller screen on another device having a larger screen. Mirroring electronic content can include simultaneously or near-simultaneously displaying electronic content on both the computing device (e.g., a smart phone, a tablet computer, etc.) and the larger display device (e.g., a television).

One solution for mirroring electronic content involves connecting a computing device to a display device via a cable, such as a Video Graphics Array (“VGA”) cable, a High-Definition Multimedia Interface (“HDMI”) cable, etc. Another solution for mirroring electronic content involves wirelessly connecting a computing device to a display device via a specialized adapter. For example, a user may plug a dongle into a television that allows the television to wirelessly receive audio and video data from a computing device.

These prior solutions present disadvantages. One disadvantage is that different manufacturers of computing devices may provide different technologies for connecting the computing devices to the same type of display device. Another disadvantage is that a given display device may include a physical connection port that is not compatible with a given computing device. These and other limitations of prior solutions may inhibit the ability to mirror content from different types of computing devices to different types of display devices.

### SUMMARY

Systems, devices, and methods are described for establishing bidirectional communication among computing devices.

For example, a wireless access point may perform a method that facilitates discovery of multiple computing devices and/or collaboration among the computing devices. The method involves the access point establishing a communication link with a first computing device. The method also involves the access point identifying, based on communications between the first computing device and the access point, an application executed on the first computing device. The method also involves the access point determining that a second computing device that is in communication with the access point can present outputs generated by the application and generate input events usable by the application. The method also involves the access point transmitting a notification to the first computing device that the second computing device is accessible via the access point. The access point can transmit the notification based on determining that the second computing device can present the outputs and generate the input events that are usable by the application.

These illustrative examples are mentioned not to limit or define the disclosure, but to provide examples to aid understanding thereof. Additional aspects and examples are discussed in the Detailed Description, and further description is provided there.

### BRIEF DESCRIPTION OF THE FIGURES

These and other features, aspects, and advantages of the present disclosure are better understood when the following Detailed Description is read with reference to the accompanying drawings, where:

FIG. 1 is a block diagram depicting an example of a computing environment in which one or more access points can facilitate bidirectional communication among computing devices according to certain aspects of the present invention.

FIG. 2 is a block diagram depicting examples of a user device and output devices that can communicate with one another via an access point according to certain aspects of the present invention.

FIG. 3 is a flow chart depicting an example of a method for using an access point to establish bidirectional, application layer communication among computing devices according to certain aspects of the present invention.

FIG. 4 is a diagram depicting an example of an interface that may be presented at a user device for facilitating communication with one or more output devices accessible via an access point according to certain aspects of the present invention.

FIG. 5 is a diagram depicting another example of an interface that may be presented at a user device for facilitating communication with one or more output devices accessible via an access point according to certain aspects of the present invention.

FIG. 6 is a modeling diagram depicting an example of using an access point to share output events between a user device and an output device according to certain aspects of the present invention.

FIG. 7 is a modeling diagram depicting an example of using an access point to share output events generated by a user device browsing a website according to certain aspects of the present invention.

FIG. 8 is a modeling diagram depicting an example of using an access point to share output events with a user device that are generated by a computing device that is communicatively coupled to an output device via a data connection other than the access point according to certain aspects of the present invention.

FIG. 9 is a modeling diagram depicting an example of an access point that can be used for establishing communications among three or more computing devices according to certain aspects of the present invention.

FIG. 10 is a block diagram depicting examples of an access point and computing devices that can communicate with the access point according to certain aspects of the present invention.

### DETAILED DESCRIPTION

Computer-implemented systems and methods are disclosed for providing a wireless access point that can establish bidirectional, application layer communication links among nearby computing devices.

The following non-limiting example is provided to help introduce the general subject matter of certain aspects. A wireless access point can be positioned in a room or other geographical location. Other computing devices configured for wireless communication that may be co-located with or otherwise in proximity to the wireless access point can communicate with the access point, either via a wireless interface or via a communication cable. The wireless access point can discover services that are offered by each of the computing devices and that can be used by other computing devices. For example, a first computing device may be a tablet computer. A second computing device may be an interactive white board or other touchscreen device or system that can be viewed by multiple individuals in the room. The access point can determine that the tablet computer is executing a drawing application that can generate images or other outputs than can be displayed on the interactive white board. The access point can also determine that the interactive whiteboard can receive touchscreen inputs that may be used by the drawing application executed at the tablet computer. The access point can notify the tablet computer that the interactive whiteboard can be used by the drawing application executed at the tablet computer. The access point can also negotiate or otherwise establish a bidirectional communication link between the interactive whiteboard and the tablet computer. For example, the bidirectional communication link can be implemented via near-field communication, Bluetooth, or Wi-Fi. The bidirectional communication link can allow the whiteboard and the tablet computer to communicate application layer events (e.g., input events received by the drawing application at the tablet computer, output events generated by the drawing application and transmitted to the whiteboard, touch screen inputs received at the whiteboard and provided to the drawing application, etc.).

In accordance with some aspects, an access point may facilitate discovery of multiple computing devices. The access point may also facilitate collaboration among multiple computing devices. The wireless access point can establish a communication link with a first computing device. Establishing the communication link can include performing one or more operations involved in allowing the access point and the computing device to communicate with one another (e.g., transmitting or responding to a handshake). Establishing the communication link can involve either the access point or the computing device initiating the communication link. The wireless access point can also identify, based on communications between the first computing device and the access point, an application executed on the first computing device. The wireless access point can also determine that a second computing device that is in communication with the access point can present outputs generated by the application. For example, the second computing device may be executing program code that can receive output events generated by the application executing at the first computing device. The program code executing at the second computing device can present visual information, audio information, or other information that is generated using the received output events. The wireless access point can additionally or alternatively determine that the second computing device can generate input events usable by the application. For example, the second computing device may be executing program code that can receive input events generated by the first computing device and perform one or more algorithms that use data obtained from the input events. The wireless access point can also transmit a notification to the first computing device that the second computing device is accessible via the access point. The access point can transmit the notification based on determining that the second computing device can present the outputs and/or generate the input events that are usable by the application.

In some aspects, the wireless access point can be used to establish a bidirectional communication session between the first and second computing devices. For example, the first computing device can transmit input events and/or output events to the access point during the bidirectional communication session. The access point can transmit the input events and/or the output events to the second computing device during the bidirectional communication session. The second computing device can also transmit input events and/or output events to the first computing device via the access point during the bidirectional communication session. In additional or alternative aspects, the first communication device can establish the bidirectional communication session directly with the second computing device based on receiving the notification from the access point. For example, the first computing device can transmit a request to establish the bidirectional communication session to an address of the second computing device. The address of the second computing device can be included in the notification received from the access point or can be otherwise obtained using the notification received from the access point. The second computing device can respond to the request by performing one or more operations for establishing the bidirectional communication session. The first and second computing devices can transmit and receive input events and/or output events to one another during the bidirectional communication session without routing the transmissions through the access point.

As used herein, the term “access point” can refer to any device that is configured for electronically transmitting messages to multiple computing devices and for electronically receiving messages from multiple computing devices. In some aspects, an access point can be configured to communicate via multiple communication protocols (e.g., a near-field communication protocol, a Bluetooth communication protocol, a Wi-Fi communication protocol, an Ethernet communication protocol, etc.). In some aspects, an access point can be a stand-alone device. In other aspects, an access point can be integrated with or otherwise included in another device. For example, an interactive whiteboard or other computing device may be configured to perform one or more functions of an access point as described herein.

As used herein, the term “computing device” can refer to any device configured to execute program code. In some aspects, a computing device can be configured for relatively simple computing tasks. Non-limiting examples of such a computing device include an interactive whiteboard or other touchscreen devices configured for displaying graphics. In other aspects, a computing device can be configured for performing complex computing tasks. Non-limiting examples of such a computing device include a personal computer or a server configured for executing multiple applications.

As used herein, the term “input” can refer to any data used by an algorithm. The term “input” can also refer to actions by a user that generate one or more input events (e.g., swiping a touchscreen, pressing a key on a keyboard, moving a mouse, clicking a button on a mouse, etc.). The term “input event” can refer to a record or other data structure for storing data that describes or otherwise identifies input data to be provided to an algorithm by an input action by a user. For example, an input event may include input such as a string of characters typed into a keyboard and/or data identifying the keyboard strokes as the source of the string to be used as an input. The data included in an input event can be used as input data to an algorithm.

As used herein, the term “output” can refer to any data generating by an algorithm. The term “output” can also refer to any visual characteristic, audible characteristic, tactile characteristic, or other sensory data that may be detectable by human senses and generated by one or more components of a computing device (e.g., images on a display screen, sound emitted by speakers, etc.). The term “output event” can refer to a record or other data structure for storing data that describes or otherwise identifies output data generated by an algorithm and/or operations to be performed by an output device (e.g., audio signals to be emitted, images to be displayed, etc.). Output events can be transmitted via a data network or other communication link. In one non-limiting example, an output event can include a command for presenting a given output (e.g., a command to render a certain color on a display device). In another non-limiting example, an output event can include some or all of a given output (e.g., some or all of an image file to be displayed on a display device).

As used herein, the term “bidirectional communication session” can refer to a period of time during which at least two computing devices are authorized to communicate with one another. Bidirectional communication involves at least one message being electronically transmitted from a first computing device to a second computing device and at least one additional message being electronically transmitted from the second computing device to the first computing device. A session can be delineated by a first point in time and a second point in time. The first point in time can be a time at which a computing device (or an entity associated with a computing device) is authenticated or otherwise authorized for accessing services provided by another computing device via the access point. The second point in time can be a time at which the authentication or other authorization is terminated (e.g., via the entity logging out or the authentication or other authorization expiring after a period of inactivity).

In some aspects, an access point described herein can improve one or more functions performed by a system that includes multiple computing devices in communication with one another. The access point may additionally or alternatively provide improvements over functions performed by other access points. The access point may additionally or alternatively improve technology involved in establishing a computing environment or other system that includes multiple computing devices that may be operated by different users in a collaborative manner. In a non-limiting example, the access point described herein can allow a computing device to be automatically informed of co-located computing devices that are currently providing services that may be used by the computing device. The access point can obviate the need for the computing devices to directly communicate with each other computing device to determine which services are available at the target device. The access point can allow systems that include multiple computing devices to be established more quickly by facilitating the discovery of computing devices that can utilize one another's services and/or facilitating the establishment of communication between these computing devices.

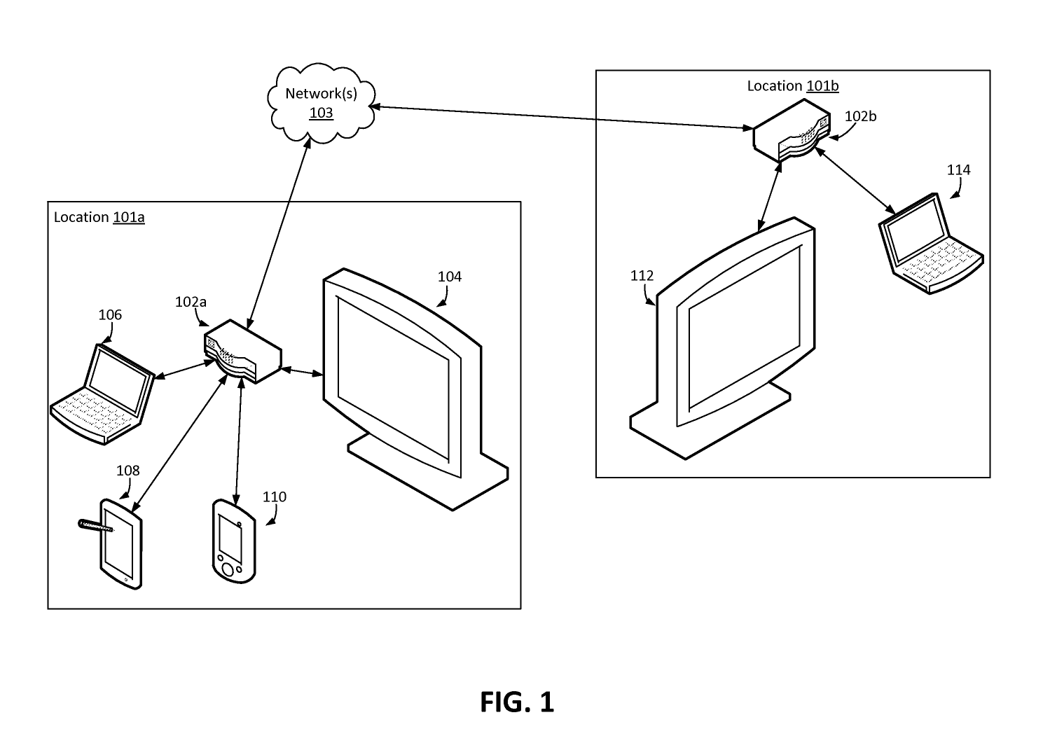

Referring now to the drawings, FIG. 1 is a block diagram depicting an example of a computing environment in which one or more access points 102a, 102b can facilitate bidirectional communication among computing devices 104, 106, 108, 110, 112, 114. In the computing environment depicted in FIG. 1, a first access point 102a is positioned in a first location 101a and a second access point 102b is positioned in a second location 101b. The access points 102a, 102b are communicatively coupled to one or more data networks 103 (e.g., via an Ethernet interface). The access point 102a can communicate with computing devices 104, 106, 108, 110, which may respectively be a laptop computer, a tablet computer, a smart phone, and an interactive panel. The access point 102b can communicate with computing devices 112, 114, which may respectively be another interactive panel and another laptop computer. A non-limiting example of an interactive panel is an interactive white board or other touch screen device that is sufficiently large to be viewed by multiple individuals in the location 101a or the location 101b. Each of the access points 102 can communicate with one or more of the computing devices 104, 106, 108, 110, 112, 114 via a wireless interface (e.g., an RF transceiver) or a wired interface (e.g., Ethernet, HDMI, etc.).

Each of the access points 102a, 102b can execute a communication application or other program code that facilitates communication among two or more of the computing devices 104, 106, 108, 110, 112, 114. For example, a communication application can configure an access point to negotiate or otherwise establish communication links with one or more of the computing devices 104, 106, 108, 110, 112, 114. These communication links may be established using any suitable protocol. In one non-limiting example, the bidirectional communication link can be implemented via Wi-Fi. In another non-limiting example, the bidirectional communication link can be implemented via near-field communication, Bluetooth, or another suitable communication protocol. The access point can receive data from a first computing device via a first near-field communication link or Bluetooth link and relay the data to a second computing device via a second near-field communication link or Bluetooth link with the second computing device. In another non-limiting example, the bidirectional communication link can be implemented using a combination of a suitable low-bandwidth communication protocol (e.g., near-field communication, Bluetooth, etc.) and Wi-Fi. For instance, the access point and a computing device can use near-field communication, Bluetooth, or another suitable low-bandwidth communication protocol to identify one another. After using a low-bandwidth communication protocol for initial identification, the access point and the computing device can establish a Wi-Fi communication link for transferring data. The communication application can additionally or alternatively configure an access point to broadcast or otherwise transmit data to other computing devices identifying the access point to the other computing devices. For example, one of the access points 102a, 102b may broadcast its presence on a data network 103 (e.g., a local area network to which the access points 102a, 102b is connected via Ethernet). Broadcasting an access point's presence can allow another one of the access points to identify the broadcasting access point. The communication application can additionally or alternatively configure an access point to store information about the capabilities of one or more of the computing devices 104, 106, 108, 110, 112, 114 that are in communication with the access point. The communication application can allow other communicatively coupled devices to discover these capabilities. The communication application can additionally or alternatively configure an access point to establish, manage, or otherwise assist bidirectional communication between two or more of the computing devices 104, 106, 108, 110, 112, 114. The communication application can additionally or alternatively configure an access point to receive communications and data from one of the computing devices 104, 106, 108, 110, 112, 114 and transmit the received communications and data to another one of the computing devices 104, 106, 108, 110, 112, 114.

In some aspects, the access points 102a, 102b can be used to expose or otherwise indicate which capabilities of one or more computing devices 104, 106, 108, 110, 112, 114 are available for use by one or more other computing devices 104, 106, 108, 110, 112, 114. The access points 102a, 102b may present these capabilities as services available to one or more of the computing devices 104, 106, 108, 110, 112, 114. For example, one of the computing devices 104, 106, 108, 110, 112, 114 may advertise or otherwise indicate that it is capable of accepting incoming touch data, accepting file transfers, sharing its screen, accessing a shared workspace, accessing a cloud-based service, etc. The services available from the computing devices 104, 106, 108, 110, 112, 114 can be determined by program code that is executed on the computing devices 104, 106, 108, 110, 112, 114. For example, the access points 102a, 102b may include software or firmware installed by a manufacturer that determines the services available from the access points 102a, 102b. One or more of the computing devices 104, 106, 108, 110, 112, 114 may include software or firmware installed by an end user (e.g., an application downloaded from a web site) or installed by a manufacturer (e.g., software or firmware for an interactive panel, such as the computing devices 104, 112).

Communication links can be established among the access points 102a, 102b and one or more of the computing devices 104, 106, 108, 110, 112, 114 in any suitable manner. For example, one of the computing devices 104, 106, 108, 110, 112, 114 can be used to establish a connection to a wireless access point 102a by tapping and holding the computing device against the access point 102a (i.e., using near-field communication), by establishing a Bluetooth connection, or by establishing a Wi-Fi connection. In some aspects, the access point 102a can assign a unique identifier to a computing device that establishes a communication link with the access point 102a.

In a non-limiting example, once one of the computing devices 104, 106, 108, 110, 112, 114 is connected to one of the access points 102a, 102b, the access point can poll the computing device for a list of available services from the computing device. Any other one of the computing devices 104, 106, 108, 110, 112, 114 that is communicatively coupled to any one of the access points 102a, 102b can query the access point to obtain a list of other computing devices and services available via the access point. An application executed on a computing device can display the list of available devices and services obtained from the access point. The communication among the access points 102a, 102b and the computing devices 104, 106, 108, 110, 112, 114 can be performed using the application layer protocol.

In some aspects, a user may access a service on one of the computing devices 104, 106, 108, 110, 112, 114 by selecting the appropriate target device and desired service from a list of available devices and services that has been obtained from one of the access points 102a, 102b. The access point can transmit a request for access to the target device. The target device can respond to the access point with a message indicating that the request is granted or denied. If the request is granted, the access point can send a message to the requesting device with the information necessary to negotiate a connection with the target device. The requesting device and target device can perform a handshake and can begin exchanging data.

One or more of the computing devices 104, 106, 108, 110, 112, 114 can establish a connection with more than one other computing device at a time. In some aspects, a master/slave relationship may be established between two of the computing devices 104, 106, 108, 110, 112, 114. One or more of the access points 102a, 102b can facilitate establishing the master/slave relationship by, for example, determining which computing device is the master and which computing device is the slave.

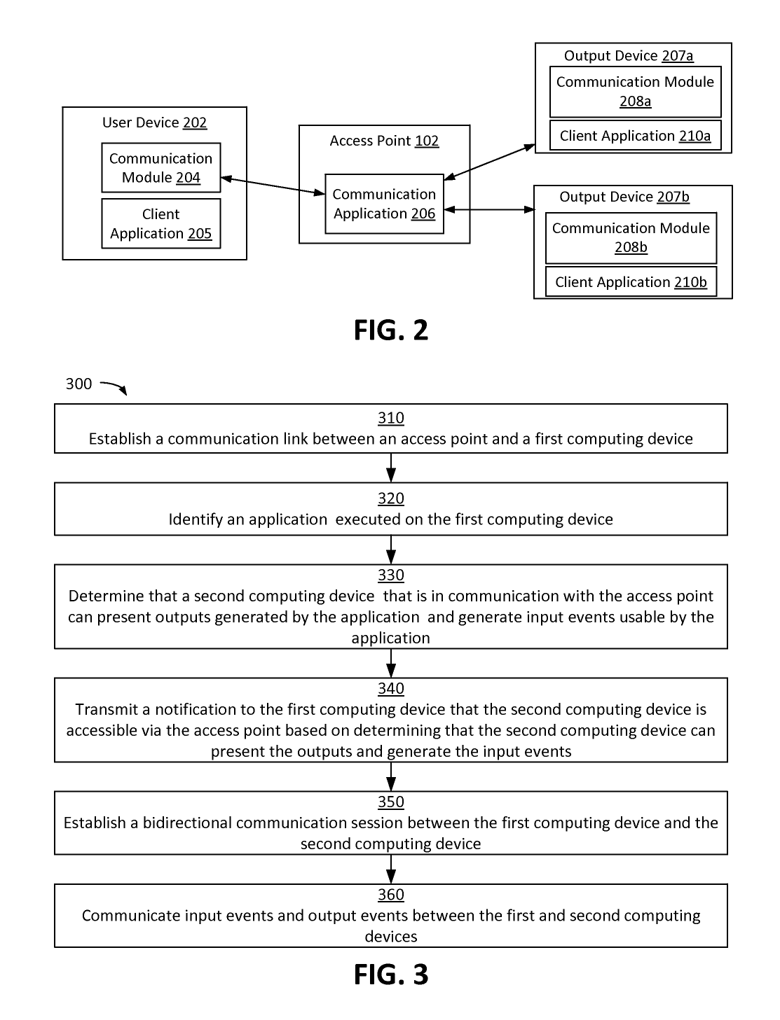

FIG. 2 is a block diagram depicting examples of a user device 202 and output devices 207a, 207b that can communicate with one another via an access point 102 according to certain aspects. The user device 202 can include any suitable computing device, such as, but not limited to, a smart phone, a tablet computer, a laptop computer, a desktop computer, etc. The output devices 207a, 207b can include, be included in, or be communicatively coupled to any suitable computing devices in communication with the access point 102 (e.g., the computing devices 104, 106, 108, 110, 112, 114).

The access point 102 depicted in FIG. 2 can execute a communication application 206. The communication application 206 can include program code executable by one or more processing devices in the access point 102. The program code can be included in software or firmware installed on the access point 102. Executing the communication application 206 can configure the access point 102 to perform one or more operations for facilitating bidirectional communication among different computing devices, as described in detail herein.

The user device 202 can execute a communication module 204. The communication module 204 can include program code executable by one or more processing devices in the user device 202. The program code can be included in software or firmware installed on the user device 202. Executing the communication module 204 can configure the user device 202 to perform one or more operations for communicating with the access point 102, as described in detail herein. The user device 202 can also execute a client application 205. The client application 205 can include any program code that may configure the user device 202 to receive inputs and/or generate outputs. Non-limiting examples of a client application 205 include a drawing application, a text editing application, a web browsing application, etc.

The output devices 207a, 207b can execute respective communication modules 208a, 208b. The communication modules 208a, 208b can include program code executable by one or more processing devices in each of the output devices 207a, 207b. The program code can be included in software or firmware installed on the output devices 207a, 207b. Executing the communication modules 208a, 208b can configure the output devices 207a, 207b to perform one or more operations for communicating with the access point 102, as described in detail herein. The output devices can also execute respective client applications 210a, 210b. Each of the client applications 210a, 210b can include program code that configure a respective one of the output devices 207a, 207b to display or otherwise present outputs (e.g., visual data, audio data, etc.).

In some aspects, the communication application 206 and the communication modules 204, 208a, 208b can allow device agnostic communication between the user device 202 and the output devices 207a, 207b. Device agnostic communication can include multiple devices being able to communicate regardless of a particular hardware and/or software configuration of each device. For example, each of the user device 202 and the output devices 207a, 207b can be any type of computing device executing any type of operating system. The use of application layer messaging among the access point 102, the user device 202, and the output devices 207a, 207b can facilitate device agnostic communication. The communication application 206 and the communication modules 204, 208a, 208b can generate application layer messages that may be transmitted by their respective devices. The communication application 206 and the communication modules 204, 208a, 208b can receive and process application layer messages that may be received by their respective devices. For example, the communication application 206 can communicate application layer messages with one or more of the communication modules 204, 208a, 208b.

Although, for illustrative purposes, FIG. 2 depicts a single user device 202 executing a single client application 205 and two output devices 207a, 207b that each execute a single respective client application, other implementations are possible. Any number of computing devices (e.g., user devices, output devices, etc.) and any type of computing devices (e.g., tablets, laptops, interactive whiteboards, etc.) may each execute any number of client applications that generate input events and/or output events that can be communicated via any number of access points.

Although, for illustrative purposes, FIG. 2 depicts communication modules as functional blocks separate from the functional blocks representing client applications, other implementations are possible. For example, a communication module may include program code that are integrated into or otherwise included in the program code of a client application.

FIG. 3 is a flow chart depicting an example of a method 300 for using an access point 102 to establish bidirectional, application layer communication among computing devices according to certain aspects. For illustrative purposes, the method 300 is described with reference to the devices depicted in FIGS. 1 and 2. Other implementations, however, are possible.

The method 300 involves establishing a communication link between an access point 102 and a first computing device, as shown in block 310. The processing device of the access point 102 can execute the communication application 206 or other suitable program code to establish a communication link. In some aspects, the processing device of the access point 102 can access and execute program code stored in a non-transitory computer-readable medium that provides an algorithm for establishing a communication link in response to receiving a request from a computing device to establish a link. For example, a computing device in the vicinity of the access point 102 can be used to select the access point 102 and transmit a message to the access point 102 for initiating the communication link. In additional or alternative aspects, the processing device of the access point 102 can access and execute program code stored in a non-transitory computer-readable medium of the access point 102 that provides an algorithm for discovering computing devices with which the access point 102 can wirelessly communicate. In additional or alternative aspects, the processing device of the access point 102 can access and execute program code stored in a non-transitory computer-readable medium of the access point 102 that provides an algorithm for detecting computing devices with which the access point 102 can communicate via communication cables.

In some aspects, the access point 102 can execute an algorithm for discovering computing devices. For example, the algorithm for discovering computing devices may be used to automatically connect to computing devices that are known to the access point 102. The discovery algorithm can involve generating a discovery signal or other suitable signal for identifying computing devices available for wireless communication. The access point 102 can generate and broadcast the discovery signal via a suitable wireless interface. Computing devices that are within the transmission range of the access point can receive the discovery signal and respond to the discovery signal. For example, one or more of the user device 202 and the output devices 207a, 207b may be configured for wireless communication. One or more of the user device 202 and the output devices 207a, 207b can receive the discovery signal and wirelessly transmit responses to the access point 102. Algorithms for processing the discovery signal and generating the responses can be provided by the communication modules 204, 208a, 208b or other suitable program code stored in non-transitory computer-readable media of the user device 202 and the output devices 207a, 207b. The access point 102 can execute the communication application 206 to perform one or more operations in response to receiving the responsive transmissions from the user device 202 and/or the output devices 207a, 207b. The operations can include establishing one or more communication links with one or more of the user device 202 and the output devices 207a, 207b.

In some aspects, an algorithm for detecting computing devices can involve monitoring signals received at a network interface or other hardware interface via which for computing devices may be communicatively coupled to the access point 102. A computing device that is communicatively coupled to the access point 102 can transmit data to the access point 102 via the network interface or other hardware interface that identifies the computing device. For example, one or more of the user device 202 and the output devices 207a, 207b may be connected to the access point 102 via a communication cable. The connected device can transmit identification data to the access point 102. Algorithms for generating and transmitting the identification data can be provided by the communication modules 204, 208a, 208b or other suitable program code stored in non-transitory computer-readable media of the user device 202 and the output devices 207a, 207b. The access point 102 can execute the communication application 206 to perform one or more operations in response to receiving the identification data from the detected device. The operations can include establishing one or more communication links with the detected device.

The method 300 further involves identifying an application executed on the first computing device, as shown in block 320. The processing device of the access point 102 can execute the communication application 206 or other suitable program code to identify the application on the first computing device.

In one non-limiting example, the access point 102 may communicate data with the user device 202 to identify a client application 205 executed on the user device 202. The client application 205 may be any application that can receive input events and generate output events by executing an algorithm that uses the input events (e.g., a drawing application, a web browsing application, a word processing application, etc.). The communication module 204 can be executed by the user device 202 to identify the client application 205. The communication module 204 can be executed by the user device 202 to generate data describing the client application 205. In some aspects, the communication module 204 can identify the client application 205 in response to a communication link being established between the access point 102 and the user device 202. In additional or alternative aspects, the access point 102 can execute the communication application 206 to generate and transmit an instruction to the communication module 204 that configures the user device 202 to identify the client application 205 to the access point 102. The communication module 204 can identify the client application 205 in response to receiving the instruction via the communication link between the access point 102 and the user device 202.

In another non-limiting example, the access point 102 may communicate data with one or more of the output devices 207a, 207b to identify client applications 210a, 210b that are respectively executed on the output devices 207a, 207b. Each of the client application 205 may be any application that can receive input events and generate output events by executing an algorithm that uses the input events (e.g., a touch screen application, a drawing application, a collaborative workspace application for sharing electronic content, an interactive educational application, etc.). Each of the communication modules 208a, 208b can be respectively executed by the output devices 207a, 207b to identify the respective client applications 210a, 210b. Each of the communication modules 208a, 208b can be respectively executed by the output devices 207a, 207b to generate data describing the respective client applications 210a, 210b. In some aspects, each of the communication modules 208a, 208b can identify the respective client applications 210a, 210b in response to a respective communication link being established between the access point 102 and each of the output devices 207a, 207b. In additional or alternative aspects, the access point 102 can execute the communication application 206 to generate and transmit an instruction to each of the communication modules 208a, 208b. The instruction can configure a respective one of the output devices 207a, 207b to identify a respective one of the client applications 210a, 210b to the access point 102. One or more of the communication modules 208a, 208b can identify the respective client applications 210a, 210b in response to receiving the instructions via the communication links between the access point 102 and the output devices 207a, 207b.

The method 300 further involves determining that a second computing device that is in communication with the access point can present outputs generated by the application executed by the first computing device and generate input events usable by the application, as shown in block 330. The processing device of the access point 102 can execute the communication application 206 or other suitable program code to determine that a second computing device can present outputs generated by the application of the first computing device and that the second computing device can generate input events usable by the application.

For example, a first computing device may be the user device 202 and a second computing device can be one or more of the output devices 207a, 207b. A processing device of the access point 102 can execute the communication application 206 to identify correlations between the functionality of the user device 202 and one or more of the output devices 207a, 207b. For example, the access point 102 can determine that the client application 205 includes one or more algorithms that receive input events (e.g., input generated by mouse clicks, touch screen inputs, keyboard strokes, etc.) and generate outputs presented at the user device 202 (e.g., drawings or other visual data displayed on a screen of the user device 202, audio data played by a speaker of the user device 202, etc.). The access point 102 can also determine that at least some inputs generated by using one or more of the output devices 207a, 207b (e.g., touch screen inputs) are included in a set of inputs that can be used by the algorithms of the client application 205. The access point 102 can also determine that at least some outputs that can be presented by one or more of the output devices 207a, 207b (e.g., display of visual data) are included in a set of outputs that can be generated by the algorithms of the client application 205.

In some aspects, the communication application 206 can query one or more of the communication modules 204, 208a, 208b to verify that inputs and/or outputs used or generated by one of the client applications 205, 210a, 210b can be utilized by another of the client applications 205, 210a, 210b. In additional or alternative aspects, the communication application 206 can reference data stored in a non-transitory computer-readable medium of the access point that describes the client applications 205, 210a, 210b. The data describing the client applications 205, 210a, 210b can indicate whether inputs and/or outputs used or generated by one of the client applications 205, 210a, 210b can be utilized by another of the client applications 205, 210a, 210b.

In some aspects, one or more operations described above with respect to blocks 310-330 can be performed in response to a user device 202 or other computing device requesting access to one of the output devices 207a, 207b or another computing device. For example, an identifier for a given output device may be presented in an interface at the output device (e.g., by displaying a quick response code with a network address of the output device). The identifier for the output device can be inputted to the user device 202 (e.g., by scanning the quick response code using a camera of the user device 202). The user device 202 can transmit the identifier for the output device to the access point 102. The access point 102 may respond to receiving the identifier by determining that the output device can be utilized by the user device 202 and notifying the user device 202 that the output device is accessible via the access point 102.

In some aspects, the access point 102 can identify a second computing device and determine that the second computing device can be utilized by a first computing device via an additional access point. For example, the access points 102a, 102b may communicate with one or more of the computing devices in respective locations 101a, 101b via a first communication protocol (e.g., a near-field communication protocol, a Bluetooth communication protocol, a Wi-Fi communication protocol, etc.). The access points may communicate with one another via a network 103. The communications over the network 103 may use a second communication protocol different from the first communication protocol. For example, the second communication protocol may be a near-field communication protocol, a Bluetooth communication protocol, a Wi-Fi communication protocol, or other protocol that is different from the protocol used to communicate with other computing devices. Additionally or alternatively, the second communication protocol may be an Ethernet communication protocol for communicating via a data network 103. The access point 102a can transmit a request via the data network 103 to the access point 102b. In some aspects, the request can include data describing one or more of the computing devices in communication with the access point 102a (e.g., one or more of the computing devices 104, 106, 108, 110). The access point 102b can identify computing devices in communication with the access point 102 one of the first communication protocols (e.g., the computing devices 112, 114). The access point 102b can determine that one or more of the identified computing devices provides services that can be utilized by a computing device in communication with the access point 102a (e.g., one or more of the computing devices 104, 106, 108, 110). The access point 102b can transmit a response to the access point 102a via the network 103. The response can include data describing one or more of the computing devices 112, 114 providing services can be utilized by one or more of the computing devices 104, 106, 108, 110.

The method 300 further involves transmitting a notification to the first computing device that the second computing device is accessible via the access point based on determining that the second computing device can present the outputs and generate the input events, as shown in block 340. The processing device of the access point 102 can execute the communication application 206 or other suitable program code to notify the first computing device that the second computing device is accessible via the access point 102.

The notification can be provided in an electronic communication via the communication link between the access point 102 and the first computing device. In some aspects, the notification can be provided in an interface generated by one or more of the communication modules 204, 208a, 208b (e.g., as a pop-up window that appears on a display screen of the user device 202 or that is displayed on one or more of the output devices 207a, 207b).

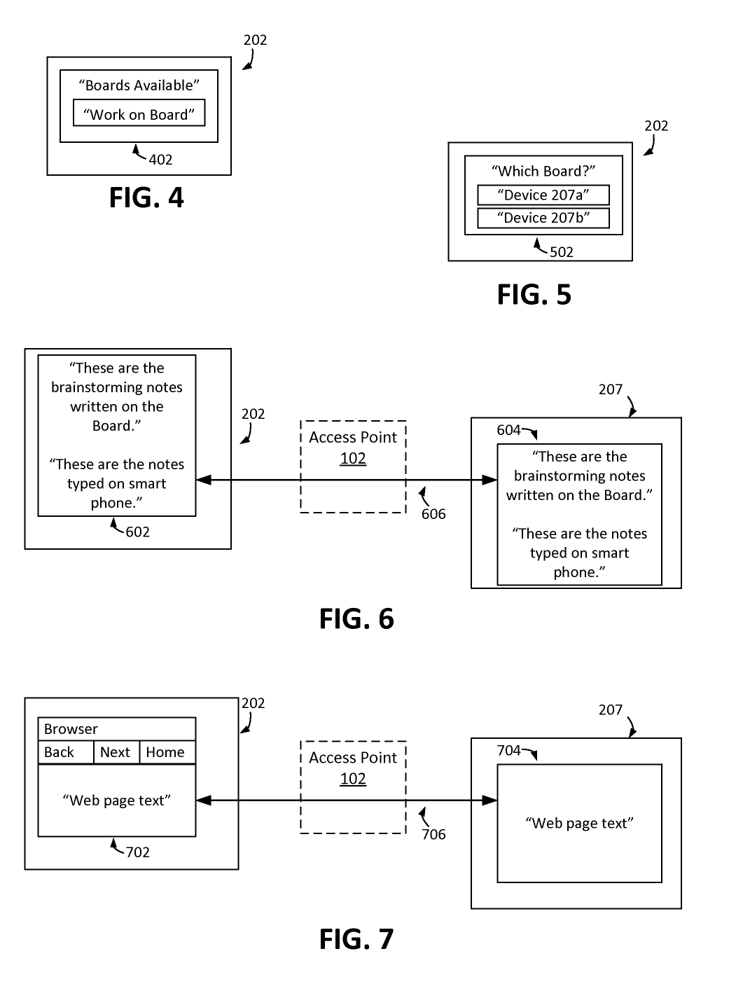

FIGS. 4 and 5 are diagrams depicting examples of interfaces that may be presented at a user device 202 for facilitating communication with one or more output devices 207a, 207b accessible via an access point 102 according to certain aspects. For example, FIG. 4 depicts an interface 402 that displays the message “Boards Available,” which indicates output devices 207a, 207b (e.g., interactive white boards) are available for access. The message “Boards Available” can be generated by the communication application 206 and transmitted to a communication module 204 of the user device 202. The communication module 204 can generate and present the interface 402 via a display screen of the user device 202. The interface 402 can also include a prompt labeled “Work on Board.” A user of the user device 202 can provide an input to the user device 202 that causes the “Work on Board” prompt to be selected. FIG. 5 depicts a list of output devices 207a, 207b identified by the communication application 206 of the access point 102. The list of output devices 207a, 207b can be generated by the communication application 206 and transmitted to the user device 202. In some aspects, the communication application 206 can generate the list and transmit the list with the message “Boards Available.” In some aspects, the communication application 206 can generate and transmit the response to the user device 202 requesting the list after receiving a selection of the “Work on Board” prompt.

In additional or alternative aspects, the communication application 206 can generate and transmit an electronic communication (e.g., an e-mail or text message) to an electronic address associated with a user of the user device 202 (e.g., an e-mail address or phone number retrieved from data stored in a non-transitory computer-readable medium of the access point). For example, a text message or e-mail may be sent to a user device 202 from the access point 102 that indicates that one or more of the output devices 207a, 207b are accessible to the user device 202 via the access point 102.

Returning to FIG. 3, the method 300 further involves establishing a bidirectional communication session between the first computing device and the second computing device, as shown in block 350. The processing device of the access point 102 can execute the communication application 206 or other suitable program code to establish the bidirectional communication session. Non-limiting examples of protocols that may be used to implement the bidirectional communication session include one or more of a near-field communication protocol, a Bluetooth protocol, a Wi-Fi protocol, etc.

A session can include a period of time during which at least one of the communication modules 204, 208a, 208b is authorized to communicate with another one of the communication modules 204, 208a, 208b via the access point 102. In some aspects, the bidirectional communication session can involve synchronous communication between the computing devices that communicate via the access point 102. Synchronous communication can include input events and output events generated by one computing device being communicated with another computing device via the access point during the bidirectional communication session (i.e., after a first point in time at which the bidirectional communication session is established and before a second point in time at which the bidirectional communication session is terminated). For example, input events and/or output events can be shared in real time or near-real time between computing devices via the bidirectional communication session.

In some aspects, establishing or otherwise facilitating the bidirectional communication session can involve determining that one of the computing devices is authorized to access or otherwise communicate with another one of the computing devices via the access point 102. For example, a user device 202 can be used to select one of the output devices 207a, 207b (e.g., by selecting an identifier for one of the output devices 207a, 207b that is presented in an interface at the user device 202). The user device 202 can execute the communication module 204 and thereby transmit a request to the access point 102 to access the selected output device. The access point 102 can execute the communication application 206 to identify the selected output device and transmit a request to the selected output device to allow access by the user device 202. The selected output device can execute a communication module to transmit a response to the access point 102. In some aspects, the response can indicate that the user device 202 is permitted to communicate with the selected output device or that that the user device 202 is prohibited from communicating with the selected output device. In other aspects, the response can request that one or more authorization actions be performed prior to permitting the user device 202 to communicate with the selected output device. Authorizing the user device 202 to access the selected output device can involve allowing the user device 202 to access some or all features of an application executed on the selected output device.

Any suitable process can be used for authorizing one computing device to establish a bidirectional communication session with another computing device via the access point. In some aspects, an authorization action can involve transmitting authentication information (e.g., user name, password, etc.) from a requesting computing device to a selected computing device via the access point 102. In other aspects, an authorization action can involve performing one or more actions to verify that the requesting computing device is co-located with the selected computing device (e.g., that both devices are in the same room).

For example, a user device 202 may be co-located with an output device 207a. The output device 207a may receive a request from the access point 102 to allow the user device 202 to access the output device 207a via the access point 102. In some aspects, the output device 207a may display an interface with the message “Allow connection from user device 202?” and buttons labeled “Yes” and “No.” The output device 207a may transmit a message to the user device 202 via the access point 102 that instructs a user of the device to select the appropriate button in the interface displayed on the output device (e.g. “Touch the ‘Yes’ button on the output device!”). A user of the user device 202 (or another individual in the room) can touch the “Yes” button on the interface. The output device 207a can respond to receiving the touch input to the “Yes” button by notifying the access point 102 that the user device 202 is authorized to access the output device 207a. In additional or alternative aspects, the output device 207a may display an interface with the message “Type this code on your device to connect: 1234.” The output device 207a may transmit a message to the user device 202 via the access point 102 that prompts a user of the device to enter a code. A user of the user device 202 (or another individual in the room) can enter the code displayed on the output device 207a into the user device 202 in response to the prompt. The user device 202 can transmit the code to the access point 102. In some aspects, the access point 102 can authorize the user device 202 in response to receiving the code from the user device 202 if the output device 207a has transmitted the code to the access point 102. In other aspects, the access point 102 can transmit the code received from the user device 202 to the output device 207a. The output device 207a can authorize the user device 202 in response to receiving the code from the access point 102.

The method 300 further involves communicating input events and output events between the first and second computing devices, as shown in block 360. The processing device of the access point 102 can execute the communication application 206 or other suitable program code to communicate input events and output events between the first and second computing devices.

In one non-limiting example, one or more of the user device 202 and the output devices 207a, 207b can generate input events (e.g., data describing a mouse click, a touch screen input, a keyboard stroke, etc.) in response to receiving inputs. Input events generated by one or more of the user device 202 and the output devices 207a, 207b can be transmitted to the access point 102. The access point can transmit the received input events to another one of the user device 202 and the output devices 207a, 207b. A device that receives the input events from the access point 102 can perform one or more operations using the input events. For example, a touch screen input received at one of the output devices 207a, 207b can cause the output device to generate an input event describing the touch screen input. The input event describing the touch screen input can be transmitted to the user device 202. The user device 202 can perform one or more operations in response to receiving the input event in the same manner as if the touch screen input or a similar input (e.g., a mouse click) had been received at the user device 202.

In another non-limiting example, one or more of the user device 202 and the output devices 207a, 207b can additionally or alternatively generate output events (e.g., data to be visually, audibly, or otherwise presented by a component of a computing device). Output events generated by one or more of the user device 202 and the output devices 207a, 207b can be transmitted to the access point 102. The access point can transmit the received output events to another one of the user device 202 and the output devices 207a, 207b. A device that receives the output events from the access point 102 can present data from the output events in the same manner as if the receiving device had generated the output event. For example, a user may use the user device 202 to generate a graphical output event (e.g., by browsing to a web page, by typing text that is to be presented on a display screen, by drawing a picture, etc.). A communication module 204 executed at the user device 202 can obtain the graphical output event and configure the user device 202 to transmit the graphical output event to the access point 102. The communication application 206 executed at the access point 102 can configure the access point 102 to transmit the graphical output event to one or more of the output devices 207a, 207b. One or more of the communication modules 208a, 208b can configure one or more of the output devices 207a, 207b to display visual data included in the graphical output event (e.g., a web page to which the user device 202 has browsed, text typed into the user device 202, a drawing created using the user device 202, etc.).

In some aspects, one or more operations described above with respect to blocks 310-360 may be omitted or may be performed by devices other than an access point 102. For example, two computing devices may be notified of one another's presence by an access point 102 and establish bidirectional communication without using the access point 102. In this example, the access point 102 may perform operations depicted in blocks 310-340 for facilitating bidirectional communication between two computing devices, but may not perform operations depicted in blocks 350, 360 for establishing the bidirectional communication. The operations described above with respect to blocks 350, 360 may involve the two computing devices transmitting messages directly to one another without routing messages through the access point 102.

Examples of bidirectional communication among various computing devices are depicted in FIGS. 6-9.

FIG. 6 is a modeling diagram depicting an example of using an access point 102 to share output events between a user device 202 and an output device 207 according to certain aspects. An interface 602 can be presented on a display screen of the user device 202. An interface 604 can be presented on a display screen of the output device 207. A first set of outputs (e.g. “These are the brainstorming notes written on the Board”) can be generated at the output device 207 in response to a touchscreen input (e.g., writing the text using a stylus). Output events that can be used to reproduce or otherwise present the first set of outputs can be transmitted to the user device 202 via a bidirectional communication session 606 established using the access point 102. The first set of outputs from the output events that are received by the user device 202 via the bidirectional communication session 606 can be displayed in the interface 602. A second set of outputs (e.g. “These are the notes typed on smart phone”) can be generated at the user device 202 in response to input received at the user device 202 (e.g., typing on a touch screen keyboard or a physical keyboard). Output events that can be used to reproduce or otherwise present the second set of outputs can be transmitted to the output device 207 via a bidirectional communication session 606 established using the access point 102. The second set of outputs from the output events that are received by the output device 207 via the bidirectional communication session 606 can be displayed in the interface 604.

FIG. 7 is a modeling diagram depicting an example of using an access point 102 to share output events generated by a user device 202 browsing a website according to certain aspects. An interface 702 can be presented on a display screen of the user device 202. An interface 704 can be presented on a display screen of the output device 207. A user of the user device 202 can browse a website with a client application such as a browser. A set of outputs (e.g. the display of a web page with the text “Web page text”) can be generated at the user device 202 in response to input received at the user device 202 for navigating to a given web page (e.g., by selecting one of the buttons labeled “Back,” “Next,” or “Home”). Output events usable for presenting the outputs can be transmitted to the output device 207 via a bidirectional communication session 706 established using the access point 102. The outputs from the output events that are received by the output device 207 via the bidirectional communication session 706 can be displayed in the interface 704 (i.e., a reproduction of the web page to which the user device 202 has navigated).

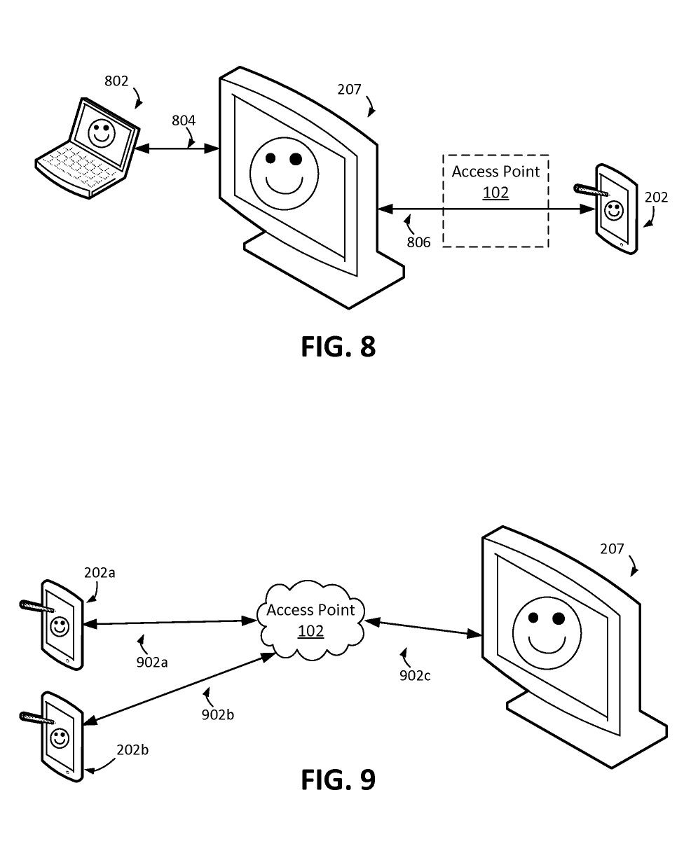

In some aspects, an access point 102 can receive output events generated by a computing device that is not communicatively coupled directly to the access point 102 and that is communicatively coupled to another computing device with which the access point 102 has established a communication link. For example, FIG. 8 is a modeling diagram depicting an example of using an access point 102 to share output events with a user device 202 that are generated by a computing device 802 that is communicatively coupled to an output device 207 via a data connection 804 other than the access point 102 according to certain aspects. As depicted in FIG. 8, the computing device 802 is communicatively coupled to output device 207 (or another computing device in communication with the access point 102) via a data connection 804. The data connection 804 is not provided by the access point 102. Non-limiting examples of the data connection 804 include a cable connection (e.g., an HDMI cable connection), a wireless connection (e.g., a Bluetooth connection), etc.

The computing device 802 can generate one or more outputs (e.g., an image of a smiley face, as depicted in FIG. 8). The computing device 802 can transmit output events usable for presenting the outputs to the output device 207 via the data connection 804. The output device 207 can display the outputs. The output device 207 can also transmit output events usable for presenting the outputs to the user device 202 via a bidirectional communication session 806 established via the access point 102. The user device 202 can display or otherwise present the outputs. In this manner, the same or similar electronic content can be displayed at the computing device 802, the output device 207, and the user device 202. In some aspects, the computing device 802 may execute a communication module that allows the computing device 802 to utilize inputs from the user device 202 that are shared as input events via the bidirectional communication session 806.

In some aspects, the computing device 802 may execute program code that configures the computing device 802 to utilize inputs from the user device 202 that are shared as input events via the bidirectional communication session 806. For example, a user of the user device 202 may type text on a portion of an interface presented at the user device 202 that includes the smiley-face. The text input may be shared with the output device 207 via the bidirectional communication session 806 such that the text is displayed in a corresponding portion of an interface presented at the output device 207 that includes the smiley-face. The text input may be transmitted from the output device 207 to the computing device 802 via the data connection 804 such that the text is displayed in a corresponding portion of an interface presented at the computing device 802 that includes the smiley-face. In some aspects, the input events shared from the user device 202 and/or the output device 207 can modify electronic content accessed by the computing device 802 (e.g., by adding text to an image file that includes the smiley-face). In additional or alternative aspects, the input events shared from the user device 202 and/or the output device 207 can be used to generate outputs that are presented at the computing device 802 without modifying any electronic content stored at or otherwise accessible to the computing device 802 (e.g., displaying text on the screen of the computing device 802 without adding the text to the image file that includes the smiley-face).

Although the systems and processes described above with respect to FIGS. 1-8 involve bidirectional communication sessions involving two computing device communicatively coupled to an access point 102, other implementations are possible. For example, FIG. 9 is a modeling diagram depicting an example of an access point 102 that can be used for establishing communications among three or more computing devices. A user device 202a can communicate with the access point 102 via a communication link 902a. A user device 202b can communicate with the access point 102 via a communication link 902b. An output device 207 can communicate with the access point 102 via a communication link 902c. Input events and output events from any one of the devices 202a, 202b, 207 can be received by the access point 102 and transmitted by the access point 102 to one or more other devices 202a, 202b, 207.

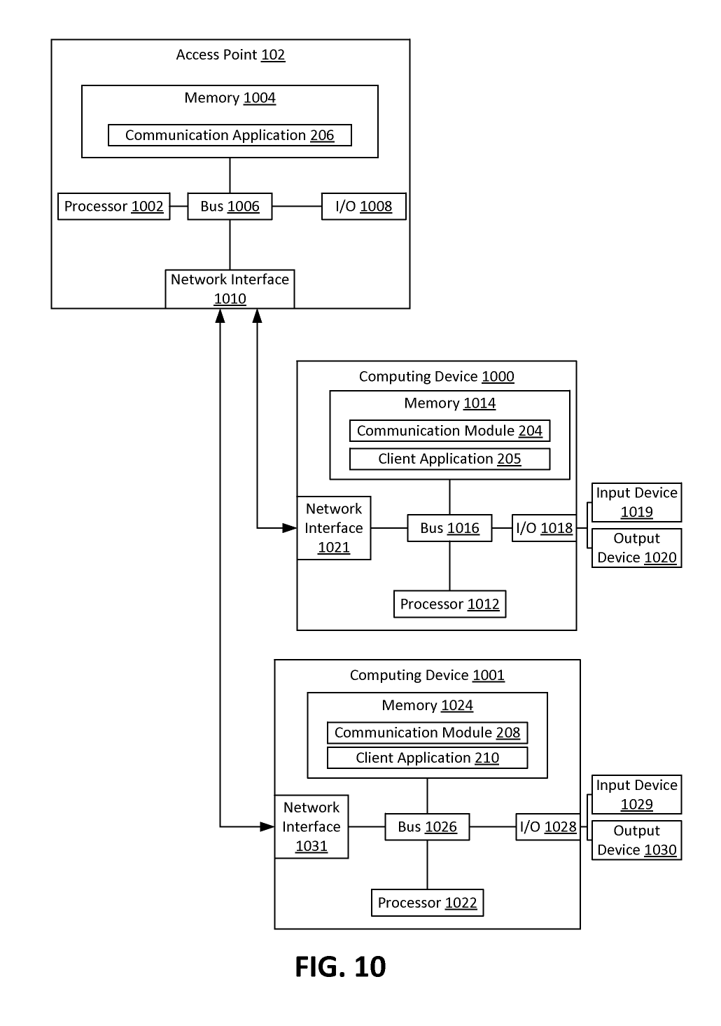

Any suitable system implementation can be used for the devices and methods described above with respect to FIGS. 1-8. For example, FIG. 10 is a block diagram depicting examples of an access point 102 and computing devices 1000, 1001 that can communicate with the access point 102 according to certain aspects. Non-limiting examples of one or more of the computing devices 1000, 1001 include the computing devices 104, 106, 108, 110, 112, 114 depicted in FIG. 1 as well as the user device 202 and output devices 207a, 207b depicted in FIG. 2.

The access point 102 and computing devices 1000, 1001 can respectively include processors 1002, 1012, 1022 that are communicatively coupled to respective memory devices 1004, 1014, 1024. The processors 1002, 1012, 1022 can execute computer-executable program code and/or access information stored in the memory devices 1004, 1014, 1024. When executed by the processors 1002, 1012, 1022, the program code stored in the memory devices 1004, 1014, 1024 can cause the processor to perform the operations described herein. Each of the processors 1002, 1012, 1022 may include a microprocessor, an application-specific integrated circuit (“ASIC”), a state machine, or other processing device. Each of the processors 1002, 1012, 1022 can include any of a number of processing devices, including one.

Each of the memory devices 1004, 1014, 1024 can include any suitable computer-readable medium. The computer-readable medium can include any electronic, optical, magnetic, or other storage device capable of providing a processor with computer-readable instructions or other program code. Non-limiting examples of a computer-readable medium include a floppy disk, CD-ROM, DVD, magnetic disk, memory chip, ROM, RAM, an ASIC, a configured processor, optical storage, magnetic tape or other magnetic storage, or any other medium from which a computer processor can read program code. The program code may include processor-specific instructions generated by a compiler and/or an interpreter from code written in any suitable computer-programming language, including, for example, C, C++, C#, Visual Basic, Java, Python, Perl, JavaScript, and ActionScript.

The access point 102 and the computing devices 1000, 1001 can also respectively include buses 1006, 1016, 1026. Each of the buses 1006, 1016, 1026 can communicatively couple one or more components of a respective one of the access point 102 and the computing devices 1000, 1001.

The access point 102 and the computing devices 1000, 1001 can also respectively include a number of external or internal devices such as input or output devices. For example, the access point 102 and the computing devices 1000, 1001 can include input/output (“I/O”) interfaces 1008, 1018, 1028. Each of the I/O interfaces 1008, 1018, 1028 can receive input from input devices or provide output to output devices. For example, the computing device 1000 can include one or more input devices 1019 and one or more output devices 1020, and the computing device 1001 can include or be communicatively coupled to one or more input devices 1029 and one or more output devices 1030. The one or more input devices 1019 and one or more output devices 1020 can be communicatively coupled to the I/O interface 1018, and the one or more input devices 1029 and one or more output devices 1030 can be communicatively coupled to the I/O interface 1028. The communicative coupling be implemented via any suitable manner (e.g., a connection via a printed circuit board, connection via a cable, communication via wireless transmissions, etc.). Non-limiting examples of input devices 1019, 1029 include a touch screen, a mouse, a keyboard, or any other device that can be used to generate input events in response to physical actions by a user of a computing device. Non-limiting examples of output devices 1020, 1030 include a touch screen, a laptop screen, an external monitor, a speaker, or any other device that can be used to display or otherwise present outputs generated by a computing device.

Although, for illustrative purposes, FIG. 10 depicts an input device 1019 and an output device 1020 as separate devices external to the computing device 1000 and depicts an input device 1029 and an output device 1030 as separate devices external to the computing device 1001, other implementations are possible. For example, a device such as a touch screen can be integrated with or communicatively coupled to a computing device. A touch screen can function as both an input device and an output device.

Program code stored in the memory devices 1004, 1014, 1024 can configure one or more of the processors 1002, 1012, 1022 to perform one or more of the operations described above with respect to FIGS. 1-8. The program code may be resident in the memory devices 1004, 1014, 1024 or any suitable computer-readable medium accessible to one of the devices depicted in FIG. 10 and may be executed by one or more of the processors 1002, 1012, 1022 or any other suitable processor. The program code stored in the memory device 1004 can include the communication application 206. The program code stored in the memory device 1014 can include a communication module 204 and a client application 205. The program code stored in the memory device 1024 can include a communication module 208 and a client application 210.

The access point 102 and the computing devices 1000, 1001 can also respectively include network interfaces 1010, 1021, 1031. The network interfaces 1010, 1021, 1031 can include any device or group of devices suitable for establishing a wired or wireless data connection. Non-limiting examples of the network interfaces 1010, 1021, 1031 include an Ethernet network adapter, a modem, and/or the like.

In some aspects, a computing system or environment can include at least one access point 102. In additional or alternative aspects, a system can be formed by establishing communication between at least one access point 102 and at least one computing device 1000. In additional or alternative aspects, a system can be formed by establishing communication among at least one access point 102, at least one computing device 1000, and at least one computing device 1001.

### General Considerations

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provide a result conditioned on one or more inputs. Suitable computing devices include multipurpose microprocessor-based computer systems accessing stored software that programs or configures the computing system from a general purpose computing apparatus to a specialized computing apparatus implementing one or more aspects of the present subject matter. Any suitable programming, scripting, or other type of language or combinations of languages may be used to implement the teachings contained herein in software to be used in programming or configuring a computing device.

Aspects of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific examples thereof, it will be appreciated that those skilled in the art, upon attaining an understanding of the foregoing may readily produce alterations to, variations of, and equivalents to such aspects and examples. Accordingly, it should be understood that the present disclosure has been presented for purposes of example rather than limitation, and does not preclude inclusion of such modifications, variations, and/or additions to the present subject matter as would be readily apparent to one of ordinary skill in the art.

1. A method comprising:
establishing, by an access point, a communication link with a first computing device;
identifying, by the access point based on communications between the first computing device and the access point, an application executed on the first computing device;
determining, by the access point, that a second computing device that is in communication with the access point can present outputs generated by the application and generate input events usable by the application; and
transmitting, from the access point to the first computing device, a notification that the second computing device is accessible via the access point based on determining that the second computing device can present the outputs and generate the input events.

2. The method of claim 1, further comprising:
establishing, via the access point, a bidirectional communication session between the first computing device and the second computing device;
communicating additional input events and the outputs from the first computing device to the second computing device via the bidirectional communication session; and
communicating the input events and output events from the second computing device to the first computing device via the bidirectional communication session.

3. The method of claim 2, wherein establishing the bidirectional communication session comprises determining that the first computing device is authorized to access the second computing device via the access point.

4. The method of claim 3, wherein the bidirectional communication session is established using at least one of a near-field communication protocol, a Bluetooth communication protocol, and a Wi-Fi communication protocol.

5. The method of claim 2, wherein the bidirectional communication session is synchronous such that the input events, the additional input events, the outputs generated by the application, and the output events from the second computing device are transmitted between the first and second computing devices during the bidirectional communication session.

6. The method of claim 2, further comprising:
receiving, by the second computing device, output events generated by a third computing device, wherein the third computing device is communicatively coupled to the second computing device via a data connection that is not provided by the access point;
transmitting, by the second computing device, the output events received via the data connection with the third computing device to the first computing device via the bidirectional communication session.

7. The method of claim 1, wherein determining that the second computing device can present the outputs and generate the input events comprises:
identifying an additional access point that is in communication with the access point via a data network using a first communication protocol;
transmitting, by the access point, a request via the data network for the additional access point to identify computing devices in communication with the additional access point via using a second communication protocol;
receiving, by the access point, a message in response to the request from the additional access point via the data network, wherein the access point determines from the message that the second computing device can present the outputs and generate the input events.

8. The method of claim 7, wherein the first communication protocol comprises at least one of a near-field communication protocol, a Bluetooth communication protocol, a Wi-Fi communication protocol, and an Ethernet communication protocol;
wherein the second communication protocol comprises another of the near-field communication protocol, the Bluetooth communication protocol, the Wi-Fi communication protocol, and the Ethernet communication protocol.

9. The method of claim 1, further comprising:
establishing, by the first computing device, a bidirectional communication session between the first computing device and the second computing device;
communicating additional input events and the outputs from the first computing device to the second computing device via the bidirectional communication session; and
communicating the input events and output events from the second computing device to the first computing device via the bidirectional communication session.

10. The method of claim 9, wherein the bidirectional communication session is established using a first communication protocol that is different from a second communication protocol used to establish the communication link between the first computing device and the access point.

11. A system comprising:
an access point, wherein the access point comprises a processing device and a non-transitory computer-readable medium communicatively coupled to the processing device,
wherein the processing device is configured for executing program code stored in the non-transitory computer-readable medium to perform operations comprising:
establishing a communication link with a first computing device,
identifying, based on communications between the first computing device and the access point, an application executed on the first computing device,
determining that a second computing device that is in communication with the access point can present outputs generated by the application and generate input events usable by the application, and
transmitting a notification to the first computing device that the second computing device is accessible via the access point based on determining that the second computing device can present the outputs and generate the input events.

12. The system of claim 11, wherein the operations further comprise:
establishing a bidirectional communication session between the first computing device and the second computing device;
communicating additional input events and the outputs from the first computing device to the second computing device via the bidirectional communication session; and
communicating the input events and output events from the second computing device to the first computing device via the bidirectional communication session.

13. The system of claim 12, wherein establishing the bidirectional communication session comprises determining that the first computing device is authorized to access the second computing device via the access point.

14. The system of claim 13, wherein the bidirectional communication session is established using at least one of a near-field communication protocol, a Bluetooth communication protocol, and a Wi-Fi communication protocol.

15. The system of claim 12, wherein the bidirectional communication session is synchronous such that the input events, the additional input events, the outputs generated by the application, and the output events from the second computing device are transmitted between the first and second computing devices during the bidirectional communication session.

16. The system of claim 12, further comprising the second computing device, wherein the second computing device is configured for:
receiving output events generated by a third computing device, wherein the third computing device is communicatively coupled to the second computing device via a data connection that is not provided by the access point;
transmitting the output events received via the data connection with the third computing device to the first computing device via the bidirectional communication session.

17. The system of claim 11, wherein determining that the second computing device can present the outputs and generate the input events comprises:
identifying an additional access point that is in communication with the access point via a data network using a first communication protocol;
transmitting a request via the data network for the additional access point to identify computing devices in communication with the additional access point via using a second communication protocol;
receiving a message in response to the request from the additional access point via the data network, wherein the access point determines from the message that the second computing device can present the outputs and generate the input events.

18. The system of claim 17, wherein the first communication protocol comprises at least one of a near-field communication protocol, a Bluetooth communication protocol, a Wi-Fi communication protocol, and an Ethernet communication protocol;
wherein the second communication protocol comprises another of the near-field communication protocol, the Bluetooth communication protocol, the Wi-Fi communication protocol, and the Ethernet communication protocol.

19. The system of claim 11, further comprising the first computing device, wherein the first computing device is configured for establishing a bidirectional communication session between the first computing device and the second computing device and communicating additional input events and the outputs to the second computing device via the bidirectional communication session.

20. The system of claim 19, wherein the bidirectional communication session is established using a first communication protocol that is different from a second communication protocol used to establish the communication link between the first computing device and the access point.
